(19) United States
(12) Patent Application Publication
(10) Pub. No.: US 2018/0247214 A1
(43) Pub. Date: Aug. 30, 2018

(54) NETWORK NODE ANALYSIS AND LINK GENERATION SYSTEM

(71) Applicant: LinkedIn Corporation, Sunnyvale, CA (US)

(72) Inventor: Afshin Ganjoo, San Jose, CA (US)

(21) Appl. No.: 15/444,856

(22) Filed: Feb. 28, 2017

(51) Int. Cl. G06N 7/00; G06F 17/30; H04L 12/26

(52) U.S. Cl. CPC G06N 7/005; H04L 43/0876; G06F 17/30598

(57) ABSTRACT

Described are methods and systems to identify missing connections, facilitate establishing new connections, and identify new nodes within a progression path for entities. According to various embodiments, the system accesses a set of data clusters representing distinct entities, and identifies a progression path for a first entity where the progression path includes a set of nodes. The system determines a match between a subject entity and the first entity based on a current node of a progression path of the subject entity being associated with a selected node of the progression path of the first entity. The system determines that a subsequent node of the progression path of the first entity corresponds to a potential node of the progression path of the subject entity and generates a portion of a message from the subject entity to the first entity.

### TECHNICAL FIELD

The present disclosure generally relates to the technical field of network-based analysis and, in one embodiment, to analyzing a social graph to identify new graph nodes within a progression path associated with an entity.

### BACKGROUND

Network-based publication systems enable users to publish documents, pages, and other content. Users may access and view published content on the network-based publication system via a network linking the network-based publication system to a client device. A social networking system, such as LinkedIn, may allow members to declare information about themselves, such as their professional qualifications or skills. In addition to information the members declare about themselves, a social networking system may gather and track information pertaining to behaviors of members with respect to the social networking system and social networks of members of the social networking system. Analyzing a vast array of such information may help to formulate solutions to various problems that may not otherwise have clear solutions.

### BRIEF DESCRIPTION OF THE SEVERAL VIEWS OF THE DRAWINGS

Some embodiments are illustrated by way of example and not limitation in the accompanying drawings, in which:

FIG. 1 is a block diagram of the functional components that comprise a computer network-based social networking system, including a network analysis machine, consistent with some embodiments described herein;

FIG. 2 is a block diagram depicting components of the network analysis machine of FIG. 1, in accordance with an example embodiment;

FIG. 3 is a flow diagram illustrating a method of analyzing a social network to identify new nodes within a progression path and establish connections between members of the social network, according to some embodiments;

FIG. 4 is a flow diagram illustrating a method of analyzing a social network to identify new nodes within a progression path and establish connections between members of the social network, according to some embodiments;

FIG. 5 is a flow diagram illustrating a method of analyzing a social network to identify new nodes within a progression path and establish connections between members of the social network, according to some embodiments;

FIG. 6 is a flow diagram illustrating a method of analyzing a social network to identify new nodes within a progression path and establish connections between members of the social network, according to some embodiments; and

FIG. 7 is a block diagram of a machine in the form of a computing device within which a set of instructions, for causing the machine to perform any one or more of the methodologies discussed herein, may be executed.

### DETAILED DESCRIPTION

Example methods and systems for analyzing a social network to identify new nodes within a progression path associated with an entity within the social network are described. In some example embodiments, a subject member of a social network selects a job path graphical user interface element. A network analysis machine identifies the profile of the subject member and identifies other members of the social network having a similar career path to that of the subject member. The network analysis machine determines a most likely career path for the subject member and enables the subject member to contact another member of the social network having a similar career path.

The network analysis machine enables member engagement with the social networking system by providing insight into a career path of the subject member using career paths of other members of the social networking system, and enables the subject member to seek advice from those other members. For the subject member, the network analysis machine identifies a set of members who have member profiles which are determined to be similar to the member profile of the subject member if the subject member continues on the determined career path. The network analysis machine may use various data about members to determine the match, including job titles, companies of employment, industries of employment, education levels, college matriculation, years of experience, areas of specialty, skills of members, top skills in an industry, locations of members, locations of employment, interests of the members, and other suitable information.

The network analysis machine ranks other members of the social networking system based on a probability of each member being a fit for the next node on a progression path (e.g., the career path of the subject member). The network analysis machine enables the subject member to contact the other members of the social networking system determined to be similar in terms of the career path of the subject member. In some embodiments, the social networking system enables communication between members after determinations of similarity where the other member selects a user interface element indicating a willingness to be contacted and a willingness to provide information relating to career path advancement in their own career. In some instances, communication between members, based on determinations of career path matches, may be enabled where the subject member and the member to be contacted are employed by the same company. In some situations, contact between members employed by the same company is conditioned on contemporaneous employment of the members with the same company.

By way of an example, the network analysis machine may receive a career mapping request from a member currently employed as a staff technical program manager. The network analysis machine may select members of the social networking system who are principal technical program managers, managers of staff technical program managers, members who became developers or development managers after being technical program managers, members who became professors after being technical program managers, and other members having backgrounds indicating a match with the subject member. In some instances, the network analysis machine may receive a specified position within the career mapping request. The specified position may be selected from a set of positions (e.g., potential nodes on a progression path) determined from the member profile of the subject member (e.g., a historical career path or set of held positions).

In some embodiments, the network analysis machine uses similar profile strategies in real-time, or near real-time, to create individual or unique comparisons between members. The career path solutions and comparisons may be determined between two member profiles being compared, without comparing profiles of additional members. In some instances, the network analysis machine performs the comparisons without normalization across profiles to detect subtle similarities between the compared members.

Social networking services of the social networking system provide various profile options and services. In some instances, a social network may connect members (e.g., individuals associated with the social network) and organizations alike. Social networking services have also become a popular method of performing organizational research and job searching. Job listings representing openings (e.g., employment and volunteer positions) within an organization may be posted and administered by the organization or third parties (e.g., recruiters, employment agencies, etc.).

A social networking system may have a vast array of information pertaining to members of the social networking system, companies maintaining a social networking presence on the social networking system, and interactions between members, companies, and content provided by both the members and companies to the social networking system. As will be discussed in more detail below, information pertaining to members of the social networking system can include data items pertaining to education, work experience, skills, reputation, certifications, and other qualifications of each of the members of the social networking system at particular points during the careers of these members, or interaction data indicating a history of interactions with content on the social networking system. This information pertaining to members of the social networking system may be member-generated to enable individualization of social networking profiles as well as to enable dynamic and organic expansion and discovery of fields of experience, education, skills, and other information relating to personal and professional experiences of members of the social networking system.

As described in more detail below, some embodiments of the present disclosure enable identification and presentation of recommendations tailored to a specified member of the social networking system. The recommendations enable the member to identify a next level up in a career, such as a career move, a promotion, or an industry change. Such recommendations may identify career changes which are not direct vertical moves, such as a direct promotion. Such career changes may be based on aspects of the member's profile on the social networking system or a member's career path. In some instances, recommendations are presented and message portions are prepared, enabling the member to contact another member of the social networking system who may already be in a position recommended by the career change. In some embodiments, systems and methods of the present disclosure facilitate the career change or job change of the member by performing job searches to identify open positions corresponding to a potential career or job change identified by the methods described below.

In some embodiments, the present systems and methods use profile or career path comparison strategies in real time or near real time to create an individualized solution or recommendation for a single specified member. In such embodiments, the methods and systems maintain temporal and situational accuracy for such solutions or recommendations. Further, such temporal and situational accuracy may be maintained despite normalization operations in identifying the solutions or recommendations. The individualized solutions and recommendations generated by some embodiments of the present disclosure enable identification of more subtle similarities between members of the social networking system and career paths taken by such members.

Other aspects of the present inventive subject matter will be readily apparent from the description of the figures that follow.

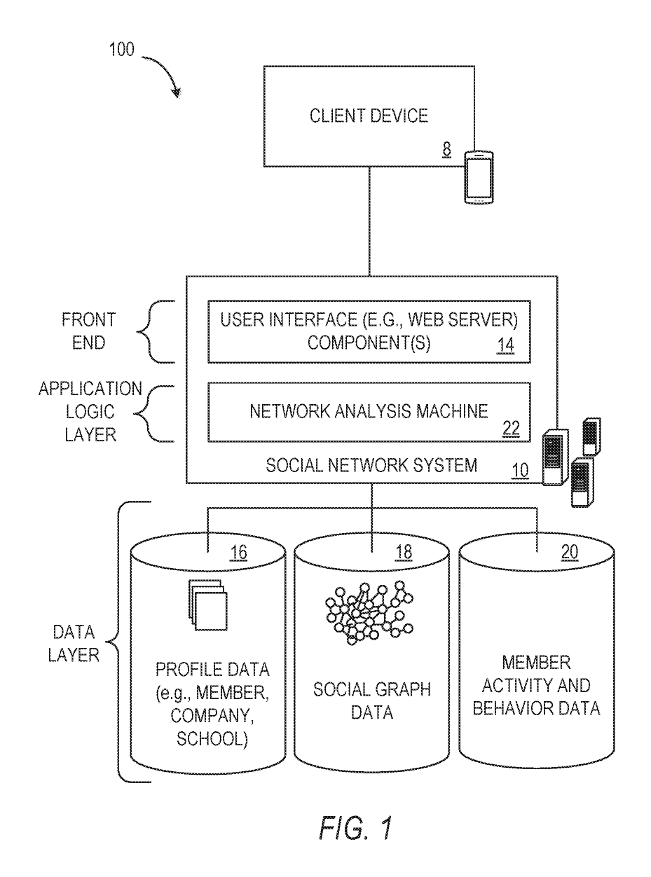

FIG. 1 is a block diagram 100 of the functional components that comprise a computer or network-based social networking system 10, consistent with some embodiments. In some embodiments, the social networking system 10 acts as a network-based publication system. In these instances, as shown in FIG. 1, the social networking system 10 is generally based on a three-tiered architecture, comprising a front end layer, application logic layer, and data layer. As is understood by skilled artisans in the relevant computer and Internet-related arts, each component or engine shown in FIG. 1 represents a set of executable software instructions (e.g., an instruction set executable by a processor) and the corresponding hardware (e.g., memory and processor) for executing the instructions. To avoid obscuring the inventive subject matter, various functional components and engines that are not germane to conveying an understanding of the inventive subject matter have been omitted from FIG. 1. However, a skilled artisan will readily recognize that various additional functional components and engines may be used with a social networking system 10, such as that illustrated in FIG. 1, to facilitate additional functionality that is not specifically described herein. Furthermore, the various functional components and engines depicted in FIG. 1 may reside on a single server computer, or may be distributed across several server computers in various arrangements. Moreover, although the social networking system 10 is depicted in FIG. 1 as having a three-tiered architecture, the inventive subject matter is by no means limited to such architecture.

As shown in FIG. 1, the front end comprises a user interface component 14 (e.g., a web server), which receives requests from various client devices 8, and communicates appropriate responses to the requesting client devices 8. For example, the user interface component 14 may receive requests in the form of Hypertext Transfer Protocol (HTTP) requests, or other web-based application programming interface (API) requests. The client devices 8 may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. In some embodiments, these entities include members, companies, and/or educational institutions, among possible others. Consistent with some embodiments, when a person initially registers to become a member of the social networking service, and at various times subsequent to initially registering, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, and so on. This information is stored as part of a member's member profile, for example, in the database 16. In some embodiments, a member's profile data will include not only the explicitly provided data, but also any number of derived or computed member profile attributes and/or characteristics.

Once registered, a member may invite other members, or be invited by other members, to connect via the social networking service. A “connection” may use a bilateral agreement by the members, such that both members acknowledge the establishment of the connection. Similarly, in some embodiments, a member may elect to “follow” another member. In contrast to establishing a “connection,” the concept of “following” another member typically is a unilateral operation and, at least in some embodiments, does not include acknowledgement or approval by the member who is being followed. When one member follows another, the member who is following may receive automatic notifications about various activities undertaken by the member being followed. In addition to following another member, a member may elect to follow a company, a topic, a conversation, or some other entity. In general, the associations and relationships that a member has with other members and other entities (e.g., companies, schools, etc.) become part of the social graph data maintained in a database 18. In some embodiments, a social graph data structure may be implemented with a graph database (e.g., the database 18), which is a particular type of database that uses graph structures with nodes, edges, and properties to represent and store data. In this case, the social graph data stored in the database 18 reflects the various entities that are part of the social graph, as well as how those entities are related with one another.

In various alternative embodiments, any number of other entities might be included in the social graph and, as such, various other databases may be used to store data corresponding with the other entities. For example, although not shown in FIG. 1, consistent with some embodiments, the social networking system 10 may include additional databases for storing information relating to a wide variety of entities, such as information concerning various online or offline groups, job listings or postings, photographs, audio or video files, and so forth.

In some embodiments, the social networking service may include one or more activity- and/or event-tracking components, which generally detect various member-related activities and/or events, and then store information relating to those activities/events in a database 20. For example, the tracking components may identify when a member makes a change to some attribute of his or her member profile, or adds a new attribute. Additionally, a tracking component may detect the interactions that a member has with different types of content. Such information may be used, for example, by one or more recommendation engines to tailor the content presented to a particular member, and generally to tailor the member experience for a particular member.

The application logic layer includes various application server components, which, in conjunction with the user interface component 14, generate various user interfaces (e.g., web pages) with data retrieved from various data sources in the data layer. In some embodiments, individual application server components are used to implement the functionality associated with various applications, services, and features of the social networking service. For instance, a messaging application, such as an email application, an instant messaging application, a social networking application native to a mobile device, a social networking application installed on a mobile device, or some hybrid or variation of these, may be implemented with one or more application server components implemented as a combination of hardware and software elements. Of course, other applications or services may be separately embodied in their own application server components.

As shown in FIG. 1, a network analysis machine 22 is an example application server component of the social networking system 10. The network analysis machine 22 performs operations to automatically analyze a social network to identify recommended connections based on a similarities determined between members of the social networking system 10. In some embodiments, the network analysis machine 22 operates in conjunction with the user interface components 14 to receive sets of publication data, sets of member data, and member input to generate tailored user interface presentations including tailored member search results indicating comparisons between career paths of members and potential nodes and paths for progression. For example, the network analysis machine 22 may render graphical representations of result sets indicative of member profiles or messages to individual members of the social networking system 10 having specified connections based on commonalties determined between a subject member and a selected member of the social networking system 10.

The social networking system 10 may provide a broad range of applications and services that allow members the opportunity to share and receive information, often customized to the interests of the member. For example, in some embodiments, the social networking system 10 may include a photo sharing application that allows members to upload and share photos with other members, or a slide sharing application, which allows members to upload slide decks for sharing among other members. In some embodiments, members of the social networking system 10 may be able to self-organize into groups, or interest groups, organized around a subject or topic of interest. Accordingly, the data for a group may be stored in a database (not shown). When a member joins a group, his or her membership in the group will be reflected in the social graph data stored in the database 18. In some embodiments, members may subscribe to or join groups affiliated with one or more companies. For instance, in some embodiments, members of the social networking system 10 may indicate an affiliation with a company at which they are employed, such that news and events pertaining to the company are automatically communicated to the members. In some embodiments, members may be allowed to subscribe to receive information concerning companies other than the company with which they are employed. Here again, membership in a group, a subscription or following relationship with a company or group, and an employment relationship with a company are all examples of the different types of relationships that may exist between different entities, as defined by the social graph and modeled with the social graph data of the database 18.

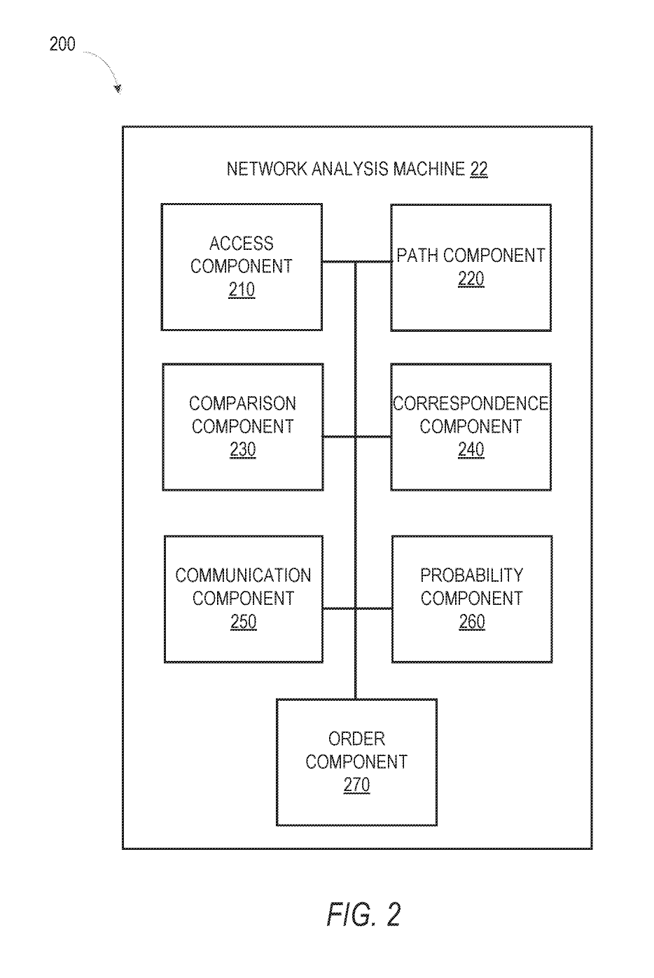

FIG. 2 is a block diagram 200 depicting some example components of the network analysis machine 22 of FIG. 1. The network analysis machine 22 is shown including an access component 210, a path component 220, a comparison component 230, a correspondence component 240, a communication component 250, a probability component 260, and an order component 270, all configured to communicate with each other (e.g., via a bus, shared memory, a switch, or a network). Any one or more of the components described herein may be implemented using hardware (e.g., one or more processors specifically configured to perform the operations described herein) or a combination of hardware and software, forming a hardware-software implemented component. For example, any component described herein may configure a processor (e.g., among one or more processors of a machine) as a special-purpose machine, during the pendency of a set of operations, to perform the operations described herein for that component. Moreover, any two or more of these components may be combined into a single component, and the functions described herein for a single component may be subdivided among multiple components.

Furthermore, according to various example embodiments, components described herein as being implemented within a single machine, database, or device may be distributed across multiple machines, databases, or devices.

The access component 210 receives or accesses a set of data clusters within a database. The access component 210 accesses the database using a cluster request indicating one or more discrete clusters or types of clusters selected for comparison. The clusters represent discrete sets of information within the social networking system 10. In some embodiments, the clusters include interrelations between members, skills, or data provided within profiles of members on the social networking system 10.

The path component 220 identifies progression paths for entities represented by member profiles within the social networking system 10. The path component 220 identifies nodes within the progression paths. The nodes may represent jobs or information relating to jobs held by members of the social networking system 10. In some embodiments, the path component 220 performs similarity operations on the nodes or progression paths to determine similarities between nodes or progression paths associated with two or more entities of the social networking system 10.

The comparison component 230 determines matches between a subject entity and one or more other entities (e.g., members of the social networking system 10) represented within the database accessed by the access component 210. The comparison component 230 may compare nodes, alone or in association with the path component 220, to compare aspects of member profiles for the entities to determine similarities to enable one or more additional components of the network analysis machine 22 to generate a progression path for the subject entity based on progression paths of other entities represented within the social networking system 10.

The correspondence component 240 determines subsequent nodes of progression paths identified for entities represented by the social networking system 10. In some embodiments, the correspondence component 240 identifies nodes along a potential progression path for the subject entity based on similarities of the nodes determined in prior portions of the progression path for the subject entity and the nodes for one or more additional entities represented on the social networking system 10.

The communication component 250 identifies communication paths (e.g., addresses) for a first entity determined by one or more other components of the network analysis machine 22 to be similar to the subject entity. In some embodiments, the communication component 250 generates portions of communications between the subject entity and the first entity. The messages generated by the communication component 250 may initiate a connection between the subject entity and the first entity based on the identified progression paths and potential progression paths or potential nodes. The communication component 250 may generate communications to initiate conversations designed to inform the subject entity on a best path to moving from the current node on the progression path to a subsequent node already accessed by the first entity. For example, the messages may enable the subject entity to inquire as to a manner in which the first entity moved from a job similar to the current node of the subject entity's progression path to a subsequent node (e.g., a new job) on the progression path of the first entity.

The probability component 260 determines probabilities for nodes of entities corresponding to a potential node within a progression path of the subject entity. The probabilities may be determined through comparison of progression paths of the subject entity and those of entities represented within the social networking system 10. A progression path for a subject entity may be a series of jobs or positions held by the subject entity. The jobs or positions may be treated as nodes (e.g., known nodes) on the progression path. In some embodiments, the progression path of the subject entity, used for comparison with other entities includes, includes all jobs or positions held by the subject entity. In some instances, the progression path includes a subset of the jobs or positions held by the subject entity. For example, the progression path may include all jobs or positions of the subject entity prior to a job or position currently held by the subject entity (e.g., a current position). Similarly, progression paths for entities being compared to the subject entity may include all or a subset of the jobs or positions held by an entity or a plurality of entities of the social networking system 10. As described in more detail below, the probability component 260 may determine probabilities of nodes as well as various progression paths including nodes based on a historical portion of the progression path of the subject entity.

The order component 270 determines orders for presentation of entities and potential nodes for the progression path of the subject entity. The order component 270 may determine the order or rank for the entities or potential nodes based on output from one or more other components of the network analysis machine 22.

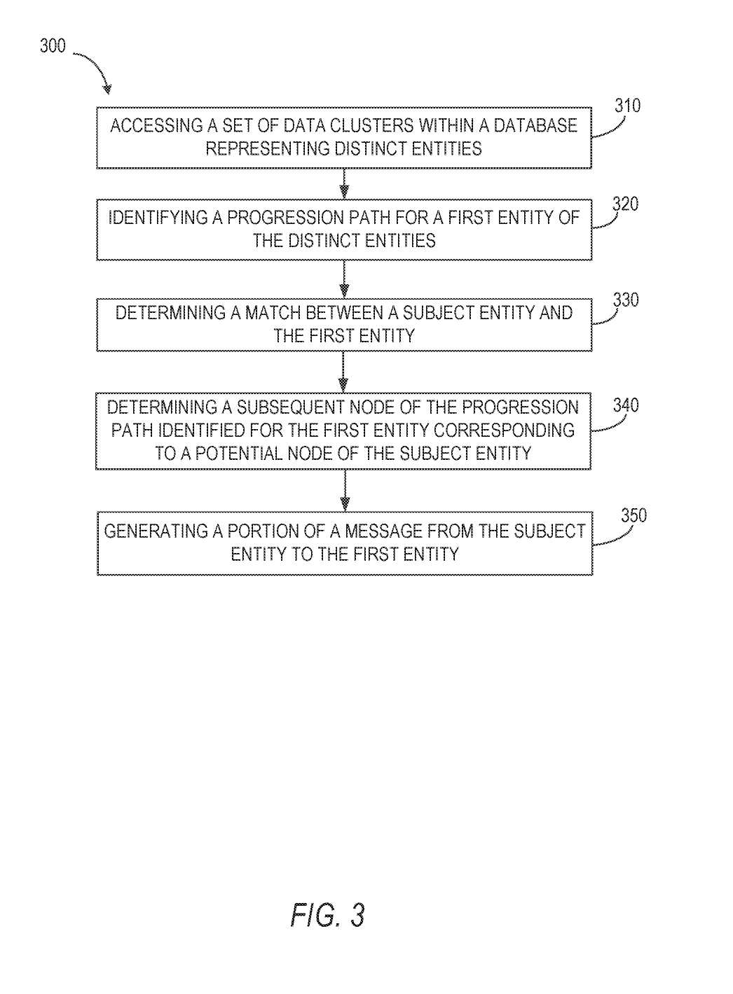

FIG. 3 is a flow diagram illustrating an example method 300 of analyzing a social network to identify new nodes within a progression path and establish connections between members of the social network, consistent with various embodiments described herein. The method 300 may be performed, at least in part, by, for example, the network analysis machine 22 illustrated in FIG. 2 (or an apparatus having similar components or operative programming, such as one or more client machines or application servers).

In operation 310, the access component 210 accesses a set of data clusters within a database. The data clusters represent distinct entities within the database. In some embodiments, the access component 210 accesses the set of data clusters within a database within or accessible by the social networking system 10. For example, the social networking system 10 may include the database 16. The database 16 may comprise one or more data structures including or combined to form a social network. In some example embodiments, the access component 210 accesses the set of data clusters by generating a cluster request indicating one or more discrete clusters or types of clusters selected for comparison. In some instances, the set of clusters accessed by the access component 210 link one or more of job titles, skills, and educational experience.

The social network may be comprised, at least in part, of member-generated profile data. The profile data includes information describing members of the social network. The profile data comprises skill titles and descriptions; job titles and descriptions; education titles, descriptions, and institutions; interrelations between members (e.g., links, relationships, endorsements, recommendations, etc.); interests; experience; publications; website links; organization affiliations; geographic locations; historical profile data, historical use data (e.g., data describing member interactions with the social networking system 10), and any other suitable information. The social network may additionally comprise cluster information for discrete portions of data contained in the profile data for members of the social networking system 10. In some embodiments, the cluster information comprises sets of data clusters indicating a network or interrelations among member-generated and member-provided data within the profiles. These data clusters may include clusters of similar or related skills, career fields, job titles, companies, geographical regions or locations, educational history, promotion history, combinations thereof, or any other suitable clusters of data selected from among the data included among the profile data of the members of the social networking system 10.

In some embodiments, the access component 210 accesses the set of clusters in response to a specified member of the social networking system 10.

For example, a specified member of the social networking system 10 may access the network analysis machine 22 through a graphical user interface (e.g., an application on a mobile computing device, a web browser, etc.). In response to the access of the network analysis machine 22, the access component 210 accesses the member profile of the specified member within the database 16 of the social networking system 10. The access component 210 selects one or more profile elements from the member profile of the specified member. The access component 210 may pass an identifier for the specified member and the one or more profile elements to one or more components of the network analysis machine 22. After accessing the one or more profile elements, the access component 210 may also access job titles, job histories, skills, and educational experience of other members of the social networking system 10 based on the set of clusters and the one or more profile elements of the specified member. The access component 210 may access the job titles, job histories, skills, and educational experience of members who have data elements within member profiles which match or are related to the one or more profile elements of the specified member. The relation of the one or more profile elements of the specified member to profile elements of other members' profiles accessed by the access component 210 may be determined using the related elements indicated by the set of clusters.

In operation 320, the path component 220 identifies a progression path for a first entity of the distinct entities represented by the set of data clusters.

The progression path includes a set of nodes. In some embodiments, the progression path is a job progression (e.g., job titles, promotions, etc.) and each node of the set of nodes is a job within the job progression. The job progression may include historical jobs of the first entity. The path component 220 may identify the progression path by accessing, alone or in combination with the access component 210, the job titles within a member profile associated with the first entity. In some embodiments, the path component 220 prunes the progression path by selecting nodes for inclusion in the set of nodes which are related.

The path component 220 may select nodes (e.g., job titles or positions) using semantic analysis to determine semantic relatedness among designations or descriptions of the set of nodes. The path component 220 may then select nodes which have a semantic similarity, indicated by a similarity score, above a predetermined or dynamic similarity threshold. Selection of the nodes using the semantic similarity scores removes nodes (e.g., positions or job titles) from the progression path which have a similarity score falling below the similarity threshold. In some embodiments, the path component 220 selects the nodes for the progression path using one or more clusters of the set of clusters. The one or more clusters may indicate a hierarchical relation among job titles or positions included among the profiles of the social networking system 10. The path component 220 selects the nodes included in the member profile of the first entity which are related, as indicated by the hierarchical relation described by the one or more clusters.

In operation 330, the comparison component 230 determines a match between a subject entity and the first entity. The match is based on a current node of the progression path identified for the subject entity being associated with the selected node of the progression path identified for the first entity. The match may be determined by identifying a designation of the current node of the progression path for the subject entity and a set of designations for nodes on the progression path of the first entity. The comparison component 230 compares the current node designation and the set of designations to identify designations of the set of designations that match the current designation. In some instances of the present disclosure designations that match the current designation are referred to as matching designations. In some embodiments, the comparison component 230 directly compares the designations to identify the match. For example, the comparison component 230 may compare the designations character by character to determine the match. The comparison component 230 may also compare hash values or any other suitable designation or version of a designation of nodes.

In some instances, the comparison component 230 determines the match between the current node and the selected node of the progression path by comparing designations or descriptions of the current node and the selected node within member profiles of the subject member and the first member, respectively. In one example embodiment, the comparison component 230 performs a semantic analysis of one or more of the title and the description of the current node and the selected node. The comparison component 230 may perform a semantic similarity comparison of the current node and the selected node. The semantic similarity comparison may be any suitable semantic similarity comparison, such as node-based similarity, natural language processing, pairwise similarity, statistical similarity, latent semantic analysis, probabilistic latent semantic analysis, or any other suitable semantic similarity comparison. In some of these embodiments, the comparison component 230 identifies words and context information within the title and description of the current node and the selected node of the respective progression paths. The comparison component 230 performs semantic analysis on the words and context information within the title and description of the nodes, and determines a similarity score. The similarity score may be a quantification of relatedness of the titles and descriptions of the nodes. In some instances, the similarity score is a percentage of terms, within the titles or descriptions of two nodes, which match or are synonyms. The percentage of terms determined by dividing the number of matching or synonymous terms by a total number of terms in one or more of the two nodes. The comparison component 230 may choose the selected node as a node from a set of nodes on the progression path of the first entity which has a highest relative similarity score or a similarity score exceeding a predetermined or dynamic similarity threshold.

In some example embodiments, the operations 320 and 330 may be performed in a single operation to identify the first entity and match the selected node in a single operation based on receiving a request for recommendation from the subject entity. In some instances, at least a portion of operation 330 may be performed prior to operation 320. In these embodiments, the comparison component 230 determines matching nodes from a plurality of progression paths of a plurality of entities (e.g., members of the social networking system 10). The path component 220 identifies the first entity and the progression path of the first entity using input from the comparison component 230 of the nodes of the plurality of progression paths matching the current node of the subject entity.

In some instances, the match may be based on one or more nodes of the progression path for the subject entity. The one or more nodes may include the current node of the progression path, or may include any node or nodes of the progression path and exclude the current node. The matching between nodes may be performed similarly to or the same as the matching described above.

In operation 340, the correspondence component 240 determines that a subsequent node of the progression path identified for the first entity corresponds to a potential node of the progression path identified for the subject entity. The subsequent node of the progression path of the first entity is a node occurring on the progression path at a time later than the selected node described in operation 330. The correspondence component 240 may determine the potential node using a probability analysis to determine a likelihood of a node being a next node in the progression path of the subject entity based on one or more of the progression path of the first entity and progression paths of one or more entities of the distinct entities represented by member profiles of the social networking system 10. The correspondence component 240 then determines the subsequent node as a node on the progression path of the first entity which matches the potential node.

In some instances, the correspondence component 240 determines the potential node of the progression path as the subsequent node of the progression path of the first entity, where the subsequent node is a next node occurring on the progression path of the first entity after the selected node which matches the current node of the progression path of the subject entity. For example, where the selected node for the first entity matches the current node of the subject entity, the subsequent node (e.g., the next node in the progression path of the first entity) may be determined as the potential node of the progression path of the subject entity.

The correspondence component 240 may determine a different subsequent node based on one or more health indicators within the social networking system 10. In these instances, the correspondence component 240 may identify health indicators for an employer associated with the subsequent node identified in operation 340. The health indicator may represent a health, a current economic status, a current level of operations, a current operating status, or other indicators of continued health or operations of the employer. For example, the health indicator may represent whether the employer is currently in business, solvent, or otherwise a suitable employer at which the subject member may seek employment. The health indicator may enable the correspondence component 240 to determine whether an employer who was healthy at the time of the first entity's employment is currently a healthy employment prospect for the subject entity. Where the correspondence component 240 determines that the health indicator for the employer is below a predetermined threshold, one or more components of the network analysis machine 22 determine an alternative node as the subsequent node. The alternative node may be another node within the progression path of the first entity or may be a node in a progression path of another entity within the social networking system 10.

In operation 350, the communication component 250 generates a portion of a message from the subject entity to the first entity. The communication component 250 may generate the message portion in response to determining the subsequent node corresponding to the potential node. In some embodiments, the portion of the message is an address line, a subject line, and an introduction. The address line may be populated by identifying information (e.g., an address, an email address, a website, etc.) for the first entity. The subject line may be populated with a subject requesting information regarding transitioning between a job indicated by the current node of the subject entity to a new job indicated by the potential node of the subject entity and the subsequent node of the first entity. The introduction may comprise an initial portion of the message introducing the subject entity to the first entity. Although described with reference to specified portions of the message being generated, the communication component 250 may generate or populate any portion or portions of a message to be transmitted to the first entity from the subject entity. In some instances, the address (e.g., identifying information) for the first entity may be obscured from view of the subject entity by the communication component 250.

In some embodiments, upon identification of the potential node as being a probable next or subsequent node on the progression path of the subject entity, one or more of the comparison component 230 and the communication component 250 performs a search to identify one or more job or position openings. The one or more job or position openings correspond to the job or position identified as the potential node (e.g., the next node or subsequent node) to which the subject entity may move. In some embodiments, the comparison component 230 and the communication component 250 identify the one or more job openings by matching title of the one or more job openings with a title of the job associated with the potential node. In some instances, the comparison component 230 and the communication component 250 select one or more keywords from a job description, or other data, associated with the potential node to search for and identify the one or more job openings. In such instances, the one or more job openings may be determined to be similar to the job associated with the potential node, based on matching the keywords, keyword synonyms, or other information within descriptions for the one or more job openings.

Upon identifying the one or more job openings, the communication component 250 generates a result list, representing the one or more job openings, and causes presentation of the result list at a client device associated with the subject entity. The result list may be an ordered list, ranked based on a similarity of the one or more job openings to the job associated with the potential node. The result list may be presented in response to a request, from the subject entity, for a job recommendation. In some instances, the result list is generated to supplement a job search performed by the subject entity, inserting the result list into a set of results from the job search of the subject entity. In some instances, the result list, or a portion thereof, may be presented in a user interface presented at the client device of the subject entity. In such instances, the result list, or a portion thereof, may be presented in a portion of a user interface indicating jobs of potential interest (e.g., “Jobs You May Be Interested In”) for the subject entity.

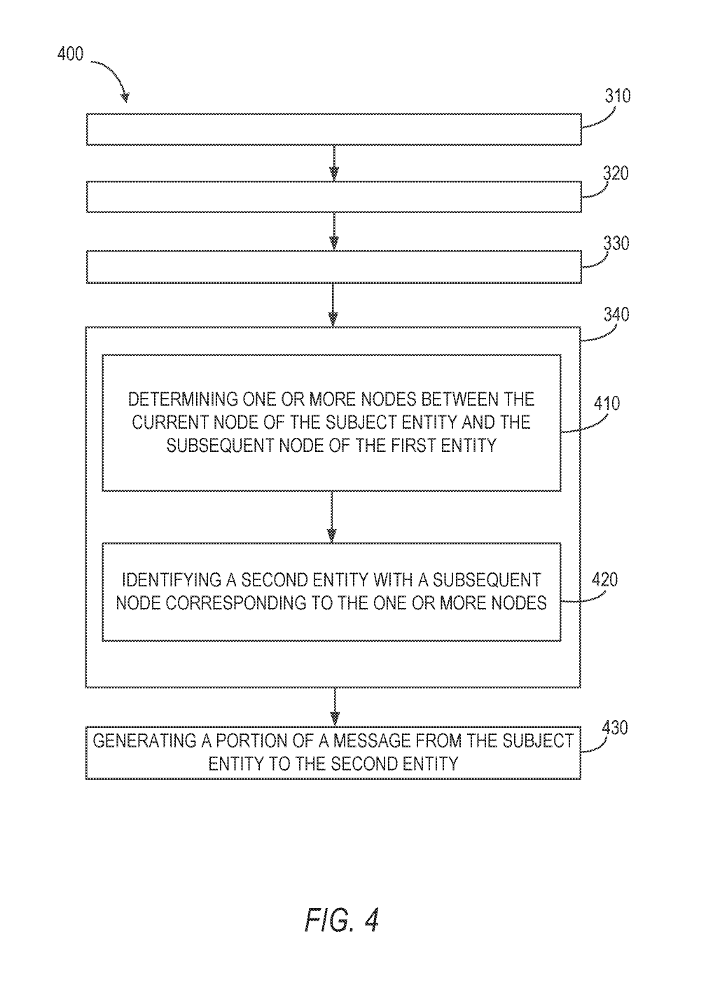

FIG. 4 is a flow diagram illustrating a method 400 of analyzing a social network to identify new nodes within a progression path and establish connections between members of the social network, consistent with various embodiments described herein. The method 400 may be performed, at least in part, by, for example, the network analysis machine 22 illustrated in FIG. 2 (or an apparatus having similar components, such as one or more client devices 8 or application servers). In some embodiments, the method 400 includes one or more operations from the method 300. In some instances, one or more operations of the method 400 is performed as a sub-operation or other part of operation 340.

The subsequent node of the progression path identified for the first entity may be positioned a distance apart from the selected node of the progression path for the first entity. In these instances, the operation 340 may include one or more operations or sub-operations. In one example embodiment, in operation 410, the correspondence component 240 determines one or more nodes between the current node of the progression path of the subject entity and the subsequent node of the progression path of the first entity. For example, the correspondence component 240 may determine a node acting as a prerequisite job between a current job of the subject entity and a desired or potential job of the first entity. The correspondence component 240 may determine the one or more nodes from a description of the subsequent node of the progression path for the first entity. In these instances, the correspondence component 240 determines one or more prerequisites, skills, educational attainments, or other information indicating a qualification for the job represented by the subsequent node. The correspondence component 240 identifies corresponding qualification information within the member profile of the subject entity within the social networking system 10. The correspondence component 240 determines one or more qualification differences (e.g., deficiencies) between the qualification information for the subsequent node and the qualification information for the current node of the progression path for the subject entity. The correspondence component 240 determines the one or more nodes (e.g., one or more jobs) corresponding to the one or more qualification differences (e.g., prerequisite jobs between the current node of the subject entity's progression path and the subsequent node of the first entity's progression path).

In operation 420, the path component 220 identifies a second entity. The second entity has a progression path with a subsequent node corresponding to the one or more nodes between the current node and the subsequent node of the first entity. The path component 220 may parse the member profiles of the entities included within the distinct entities represented within the database, described with respect to operation 310. The path component 220 identifies the second entity as an entity, among the distinct entities, having a progression path that includes a selected node corresponding to the current node of the progression path for the subject entity and a subsequent node corresponding to at least one of the one or more nodes identified in operation 410.

In operation 430, the communication component 250 generates a portion of a message from the subject entity to the second entity. The operation 430 may be performed similarly to or the same as operation 350. In some instances, the communication component 250 generates a portion of a message from the subject entity to the second entity and a portion of a second message from the subject entity to the first entity. The communication component 250 may generate message portions corresponding to the distance of the node for the entity being contacted from the current node of the subject entity. For example, the communication component 250 may generate a portion of a message indicating an immediate or proximate request for contact between the subject entity and the second entity, in response to the subsequent node for the second entity being a next node along the progression path for the subject entity. The communication component 250 may generate a portion of a message indicating a more distant meeting (e.g., suggesting a meeting in a month) or request for connection between the subject entity and the first entity, in response to the subsequent node of the first entity being spaced one or more nodes apart from the current node of the subject entity.

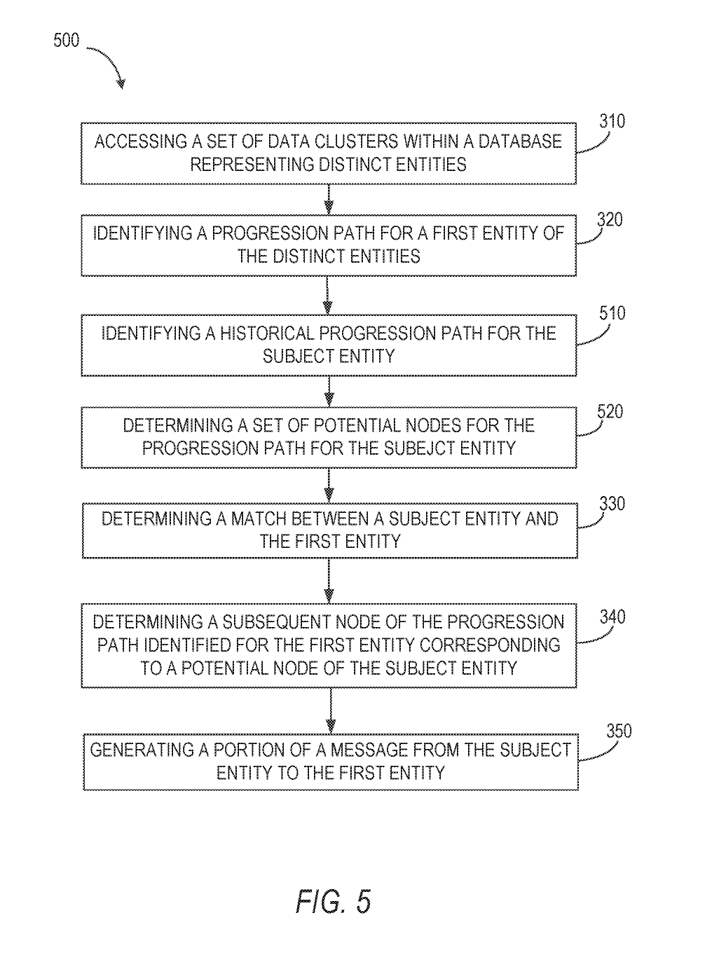

FIG. 5 is a flow diagram illustrating an example method 500 of analyzing a social network to identify new nodes within a progression path and establish connections between members of the social network, consistent with various embodiments described herein. The method 500 may be performed, at least in part, by, for example, the network analysis machine 22 illustrated in FIG. 2 (or an apparatus having similar components, such as one or more client devices 8 or application servers). In some embodiments, one or more operations of the method 500 is performed as a sub-operation or other part of one or more of the methods 300 or 400.

In some embodiments, as shown in FIG. 5, the method 500 incorporates operation 310 and 320, described above with respect to FIG. 3. In operation 510, the path component 220 identifies a historical progression path for the subject entity. The historical progression path comprises a set of historical nodes associated with the subject entity and occurring prior to a specified node (e.g., the current node). The path component 220 may determine the historical path for the subject entity by accessing the member profile of the subject entity and identifying a set of historical nodes. The set of historical nodes may represent job titles, job descriptions, previous positions held, or any other indication of a job history. In some instances, the job history includes internships, work study programs, volunteer positions, and other occupations. The path component 220, accessing the job history of the subject entity, determines each node as a discrete job or employment position held by the subject entity. The path component 220 extracts indicators for each job held by the subject entity as nodes on the historical progression path. In some instances, the path component 220 extracts predetermined or standardized indicators (e.g., encoded representations of job titles) to populate each node within the historical progression path.

In operation 520, the path component 220 determines a set of potential nodes for the progression path for the subject entity. The set of potential nodes in the progression path may be determined based on the historical progression path for the subject entity and occurring subsequent to the specified node (e.g., the current node). A portion of the nodes of the progression path correspond to the set of historical nodes. The path component 220 analyzes the historical progression path along with one or more progression paths of the distinct entities represented in the database described with respect to operation 310. Based on the historical nodes occurring in the historical progression path for the subject entity being similar to or the same as a set of nodes of a historical progression path of another entity of the distinct entities, the path component 220 may select the set of potential nodes as nodes in the historical progression path of the other entity which occur after the current node of the progression path of the subject entity. The similarity between progression paths and nodes may be determined using semantic similarity, probability analysis, or any other suitable similarity analysis. In some example embodiments, the set of potential nodes includes the potential node for the subject entity which corresponds to the subsequent node of the progression path for the first entity.

In some instances, the set of potential nodes, determined for the progression path of the subject entity, represent one or more prospective progression paths extending from the current node of the progression path of the subject entity and the historical progression path. The prospective progression paths may share nodes of the historical progression path and may diverge at the current node of the progression path of the subject entity or nodes occurring after the current node. In some embodiments, at least one of the one or more prospective progression paths maps to a progression path determined for another entity of the distinct entities represented within the database described in operation 310.

In some embodiments, as shown in FIG. 5, the method 500 includes operations of the method 300. As shown, after determining a set of potential nodes in operation 520, one or more components of the network analysis machine 22 perform operations 330-350.

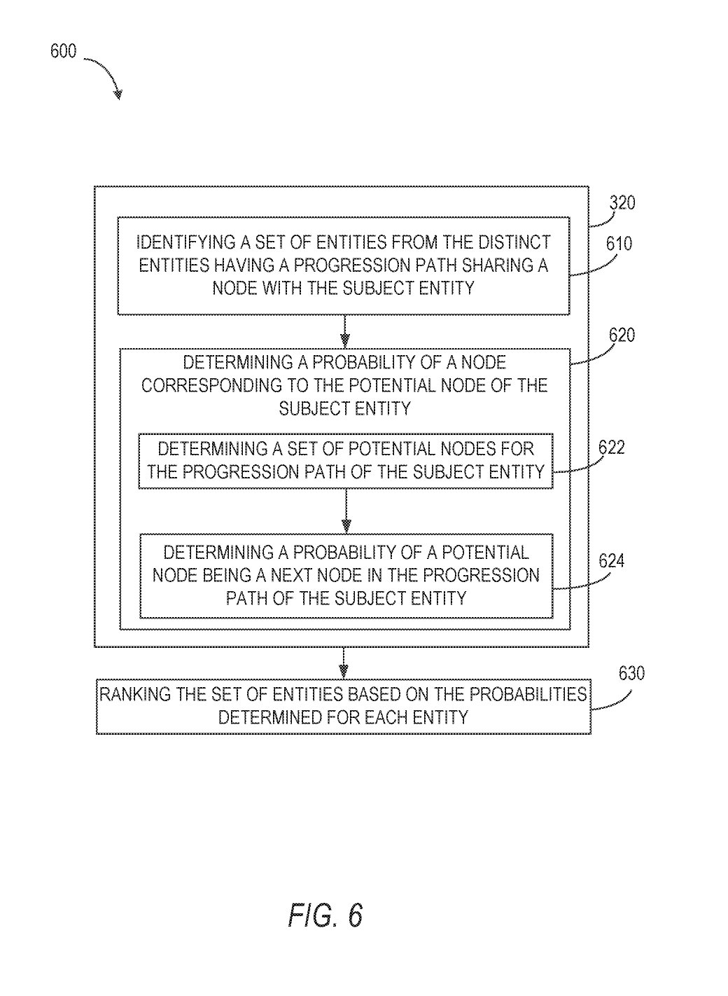

FIG. 6 is a flow diagram illustrating an example method 600 of analyzing a social network to identify new nodes within a progression path and establish connections between members of the social network, consistent with various embodiments described herein. The method 600 may be performed, at least in part, by, for example, the network analysis machine 22 illustrated in FIG. 2 (or an apparatus having similar components, such as one or more client devices 8 or application servers). In some embodiments, the method 600 includes one or more operations from the methods 300, 400, or 500. For example, the method 600 may be initiated with operation 310. In some instances, one or more of the operations of the method 600 are performed during or as a set of sub-operations of operation 320.

In some embodiments, the operation 320 includes one or more parts or sub-operations. In operation 610, the path component 220 identifies a set of entities from the distinct entities represented by the data clusters. The set of entities may be identified as having a progression path that shares one or more nodes with the subject entity.

In operation 620, the probability component 260 determines a probability of a node of each entity corresponding to the potential node of the progression path of the subject entity. The probability component 260 determines probabilities for each entity of the set of entities. The probability component 260 may determine the probability of the nodes based on a statistical distance between two nodes. The two nodes may include the current node on the progression path of the subject entity and the node being considered as a potential node.

In some instances, the probability component 260 uses a progression path for the subject entity including a series of jobs or positions held by the subject entity. The jobs or positions may be treated as nodes (e.g., known nodes) on the progression path. The nodes of the progression path may include all or a subset of the jobs or positions (e.g., nodes) held by the subject entity. The progression path for the subject entity may be a first progression path. The probability component 260 may compare the first progression path with one or more second progression paths. Each second progression path representing a progression path for an entity of the set of entities. The one or more second progression paths may include all or a subset of nodes (e.g., jobs or positions) of the entity with which a second progression path corresponds. For example, in some instances employing a subset of nodes of a second progression path, the second progression path may comprise a set of nodes from 1 to n and the subset of nodes may comprise a subset of nodes from 1 to n−1. In such examples, a current position of the entity associated with the second progression path may be excluded from comparison with the first progression path. In some embodiments, upon determining that the first progression path and the second progression path, from 1 to n−1, are a sufficient match, the final node, n, on the second progression path may be selected as the potential node for the first progression path.

In some instances, the probability component 260 determines the probability of a node using a profile similarity comparison between member profiles of the subject entity and an entity associated with a second progression path. The profile similarity comparison may generate a profile similarity score, indicating a similarity of the subject entity profile and the other entity profile. The profile similarity score may represent a number of keywords found in both the subject entity profile and the other entity profile. In some instances, a profile similarity score may be generated by dividing a number of matching keywords among two entity profiles by a total number of keywords identified for the subject entity profile or a number of keywords identified for a subset of nodes associated with the progression path of the subject entity profile.

The probability component 260 may then generate a career similarity score for the two profiles. The career similarity score may represent a number of jobs or positions found in both the subject entity profile and the other entity profile. In some embodiments, the career similarity score may be generated by dividing a number of matching jobs or positions in both the entity profiles by a total number of positions within the subject entity profile or a total number of positions, in a given field, skill set, industry, or location, within the subject entity profile. In some instances, the career similarity score is weighted based on the number of matching jobs or positions within a specified field, industry, or skill set. In such instances, matches within the specified area may increase the career similarity score more than mismatches occurring in jobs, positions, or areas other than the specified areas.

The profile similarity score and the career similarity score are then combined to generate a probability score for one or more nodes of the second progression path being the potential node for the first progression path. In some embodiments, the probability score is re-ranked, weighted, or boosted using one or more characteristic of an organization, a title, a location, and industry, or other data points indicating a higher probability of the subject entity selecting the potential node as a next position. In some instances, the probability component 260 generates the probability score using one or more of a deep learning neural network, a back-propagation neural network, or Bayesian Classification. In some examples using Bayesian Classification, the probability component 260 performs the Bayesian Classification using one or more neural networks.

In some embodiments, the operation 620 comprises one or more sub-operations. In operation 622, the path component 220 determines a set of potential nodes for the progression path for the subject entity. The set of potential nodes may be determined as nodes occurring on a progression path of an entity which shares one or more nodes with the progression path of the subject entity. In some embodiments, the potential nodes are selected and ranked based on a number of nodes on the progression path of the entity and the progression path of the subject entity. Nodes within the set of potential nodes which originate in a progression path having a relatively higher number of matching nodes with the progression path of the subject entity are placed higher in the ranking of potential nodes.

In operation 624, the probability component 260 determines a probability of a potential node being a next node in the progression path for the subject entity. In some embodiments, the potential next node may be a node of a second progression path, associated with an entity compared to the subject entity. The node of the second progression path may be excluded from an initial comparison of the first progression path of the subject entity and the second progression path (e.g., a subset of nodes) of the entity being compared. As described above, in some instances, the potential next node may be node n of the second progression path, where the subset of the second progression path, initially being compared to the first progression path, includes nodes 1 to n−1.

The probability component 260 determines the next node probability for each potential node of the set of potential nodes. The next node may be determined based on a statistical distance between the potential node and the current node or potential node occurring after the current node within a progression path. The probability component 260 may determine the probability of the potential node being the next node in the progression path of the subject entity by determining a number of times the potential node occurs as a next node from the current node in progression paths of the distinct entities within the database. The probability of the potential node being the next node may increase or decrease based on the number of times the potential node occurs as the next node in the database.

In operation 630, the order component 270 ranks the set of entities based on the probabilities determined for each entity of the set of entities. The order component 270 may rank the set of entities using the statistical distance determined for nodes within each of the progression paths of the set of entities. An entity having more nodes with a closer statistical distance to one or more nodes on the progression path of the subject entity may be ranked relatively higher by the order component 270. In embodiments where the probability component 260 determines the probability of each potential node being a next node in the progression path for the subject entity, the order component 270 ranks the set of entities based on the probabilities determined for each potential node of the set of potential nodes and the probabilities determined for each of the set of entities.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented components or objects that operate to perform one or more operations or functions. The components and objects referred to herein may, in some example embodiments, comprise processor-implemented components and/or objects.

Similarly, the methods described herein may be at least partially processor-implemented. For example, at least some of the operations of a method may be performed by one or more processors or processor-implemented components. The performance of certain operations may be distributed among the one or more processors, not only residing within a single machine or computer, but deployed across a number of machines or computers. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., APIs).

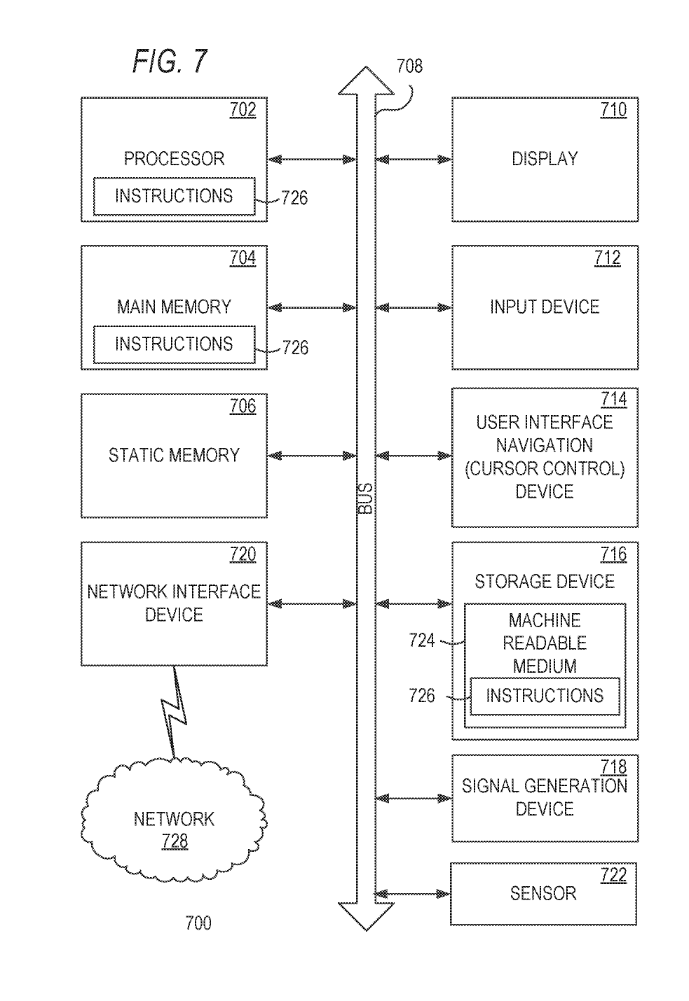

FIG. 7 is a block diagram of a machine in the form of a computer system 700 (e.g., a computing device) within which a set of instructions, for causing the machine to perform any one or more of the methodologies discussed herein, may be executed. For example, the computer system 700 may be a server functioning as the network analysis machine 22. In some instances, the computer system 700 may be a set of similar computing devices storing instructions capable of configuring a processor of the computer system 700 as one or more of the components (hardware-software implemented components) described above. The configuration of a component, even for a period of time, causes the computer system 700 to act as a special-purpose computing device for performing one or more operations associated with the component, as described in the present disclosure. In some embodiments, the computer system 700 may function as the social networking system 10 with portions (e.g., hardware and instructions) partitioned to function as one or more of the components, interfaces, or systems described above during specified operations associated with those aspects of the components, interfaces, and systems.

In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a various embodiments, the machine may be a server computer; however, in alternative embodiments, the machine may be a personal computer (PC), a tablet PC, a set-top box (STB), a personal digital assistant (PDA), a mobile telephone, a web appliance, a network router, a network switch, a network bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 includes a processor 702 (e.g., a central processing unit (CPU), a graphics processing unit (GPU), or both), a main memory 704, and a static memory 706, which communicate with each other via a bus 708. The computer system 700 may further include a display unit 710, an alphanumeric input device 712 (e.g., a keyboard), and a user interface (UI) navigation device 714 (e.g., a mouse). In one embodiment, the display unit 710, alphanumeric input device 712, and UI navigation device 714 are a touch screen display. The computer system 700 may additionally include a storage device 716 (e.g., drive unit), a signal generation device 718 (e.g., a speaker), a network interface device 720, and one or more sensors 722, such as a global positioning system sensor, compass, accelerometer, or other sensor.

The storage device 716 includes a machine-readable medium 724 on which is stored one or more sets of instructions and data structures (e.g., instructions 726) embodying or utilized by any one or more of the methodologies or functions described herein. The instructions 726 (e.g., processor-executable instructions) may also reside, completely or at least partially, within the main memory 704 (e.g., non-transitory machine-readable storage medium) and/or within the processor 702 during execution thereof by the computer system 700, with the main memory 704 and the processor 702 also constituting machine-readable media 724.

While the machine-readable medium 724 is illustrated in an example embodiment to be a single medium, the term “machine-readable medium” may include a single medium or multiple media (e.g., a centralized or distributed database, and/or associated caches and servers) that store the one or more instructions 726. The term “machine-readable medium” shall also be taken to include any tangible medium that is capable of storing, encoding, or carrying the instructions 726 for execution by the machine and that cause the machine to perform any one or more of the methodologies of the present disclosure, or that is capable of storing, encoding, or carrying data structures utilized by or associated with such instructions 726. The term “machine-readable medium” shall accordingly be taken to include, but not be limited to, solid-state memories, and optical and magnetic media. Specific examples of machine-readable media 724 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 726 may further be transmitted or received over a communication network 728 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi® and WiMax® networks). The term “transmission medium” shall be taken to include any intangible medium that is capable of storing, encoding, or carrying the instructions 726 for execution by the machine, and includes digital or analog communications signals or other intangible media to facilitate communication of such software.

Although embodiments have been described with reference to specific examples, it will be evident that various modifications and changes may be made to these embodiments without departing from the broader scope of the inventive concepts of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method, comprising:
accessing a set of data clusters within a database, the data clusters representing distinct entities within the database;
identifying a progression path for a first entity of the distinct entities represented by the set of data clusters, the progression path including a set of nodes;
determining a match between a subject entity and the first entity, the match based on a current node of a progression path identified for the subject entity being associated with a selected node of the progression path identified for the first entity;
determining that a subsequent node of the progression path identified for the first entity corresponds to a potential node of the progression path identified for the subject entity; and
in response to determining that the subsequent node corresponds to the potential node, generating a portion of a message from the subject entity to the first entity.

2. The method of claim 1, wherein the subsequent node of the progression path identified for the first entity is positioned a distance apart from the selected node of the progression path for the first entity.

3. The method of claim 2, wherein determining that the subsequent node of the progression path for the first entity corresponds to the potential node of the progression path of the subject entity further comprises:
determining one or more nodes between the current node of the progression path of the subject entity and the subsequent node of the progression path of the first entity;
identifying a second entity having a progression path with a subsequent node corresponding to the one or more nodes between the current node of the progression path of the subject entity and the subsequent node of the progression path of the first entity; and
generating a portion of a message from the subject entity to the second entity.

4. The method of claim 1, further comprising:
identifying a historical progression path for the subject entity, the historical progression path comprising a set of historical nodes associated with the subject entity and occurring prior to a specified node; and
based on the historical progression path for the subject entity, determining a set of potential nodes for the progression path for the subject entity and occurring subsequent to the specified node, a portion of nodes within the progression path of the subject entity corresponding to the set of historical nodes.

5. The method of claim 4, wherein the set of potential nodes includes the potential node of the progression path for the subject entity which corresponds to the subsequent node of the progression path for the first entity.

6. The method of claim 4, wherein the set of potential nodes determined for the progression path of the subject entity represent one or more prospective progression paths extending from the current node of the progression path of the subject entity and the historical progression path.

7. The method of claim 1, wherein identifying the progression path for the first entity further comprises:
identifying a set of entities from the distinct entities represented by the data clusters;
for each entity of the set of entities, determining a probability of a node of a progression path of the entity corresponding to the potential node of the progression path of the subject entity; and
ranking the set of entities based on the probabilities determined for each entity of the set of entities.

8. The method of claim 7, wherein determining the probability of the node of the entity corresponding to the potential node of the progression path of the subject entity further comprises:
determining a set of potential nodes for the progression path for the subject entity; and
for each potential node of the set of potential nodes, determining a probability of the potential node being a next node in the progression path for the subject entity.

9. The method of claim 8, wherein the set of entities is ranked based on the probabilities determined for each potential node of the set of potential nodes and the probabilities determined for each entity of the set of entities.

10. A system, comprising:
one or more processors; and
a processor-readable storage device comprising processor-executable instructions that, when executed by the one or more processors, cause the one or more processors to perform operations comprising:
accessing a set of data clusters within a database, the data clusters representing distinct entities within the database;
identifying a progression path for a first entity of the distinct entities represented by the set of data clusters, the progression path including a set of nodes;
determining a match between a subject entity and the first entity, the match based on a current node of a progression path identified for the subject entity being associated with a selected node of the progression path identified for the first entity;
determining that a subsequent node of the progression path identified for the first entity corresponds to a potential node of the progression path identified for the subject entity; and
in response to determining that the subsequent node corresponds to the potential node, generating a portion of a message from the subject entity to the first entity.

11. The system of claim 10, wherein the subsequent node of the progression path identified for the first entity is positioned a distance apart from the selected node of the progression path for the first entity, and wherein determining that the subsequent node of the progression path for the first entity corresponds to the potential node of the progression path of the subject entity further comprises:
determining one or more nodes between the current node of the progression path of the subject entity and the subsequent node of the progression path of the first entity;
identifying a second entity having a progression path with a subsequent node corresponding to the one or more nodes between the current node of the progression path of the subject entity and the subsequent node of the progression path of the first entity; and
generating a portion of a message from the subject entity to the second entity.

12. The system of claim 10, wherein the operations further comprise:
identifying a historical progression path for the subject entity, the historical progression path comprising a set of historical nodes associated with the subject entity and occurring prior to a specified node; and
based on the historical progression path for the subject entity, determining a set of potential nodes for the progression path for the subject entity and occurring subsequent to the specified node, a portion of nodes within the progression path of the subject entity corresponding to the set of historical nodes.

13. The system of claim 10, wherein identifying the progression path for the first entity further comprises:
identifying a set of entities from the distinct entities represented by the data clusters;
for each entity of the set of entities, determining a probability of a node of a progression path of the entity corresponding to the potential node of the progression path of the subject entity; and
ranking the set of entities based on the probabilities determined for each entity of the set of entities.

14. The system of claim 13, wherein determining the probability of the node of the entity corresponding to the potential node of the progression path of the subject entity further comprises:
determining a set of potential nodes for the progression path for the subject entity; and
for each potential node of the set of potential nodes, determining a probability of the potential node being a next node in the progression path for the subject entity.

15. The system of claim 14, wherein the set of entities is ranked based on the probabilities determined for each potential node of the set of potential nodes and the probabilities determined for each entity of the set of entities.

16. A processor-readable storage device comprising processor-executable instructions that, when executed by one or more processors of a machine, cause the machine to perform operations comprising:
accessing a set of data clusters within a database, the data clusters representing distinct entities within the database;
identifying a progression path for a first entity of the distinct entities represented by the set of data clusters, the progression path including a set of nodes;
determining a match between a subject entity and the first entity, the match based on a current node of a progression path identified for the subject entity being associated with a selected node of the progression path identified for the first entity;
determining that a subsequent node of the progression path identified for the first entity corresponds to a potential node of the progression path identified for the subject entity; and
in response to determining that the subsequent node corresponds to the potential node, generating a portion of a message from the subject entity to the first entity.

17. The processor-readable storage device of claim 16, wherein the subsequent node of the progression path identified for the first entity is positioned a distance apart from the selected node of the progression path for the first entity, and wherein determining that the subsequent node of the progression path for the first entity corresponds to the potential node of the progression path of the subject entity further comprises:
determining one or more nodes between the current node of the progression path of the subject entity and the subsequent node of the progression path of the first entity;
identifying a second entity having a progression path with a subsequent node corresponding to the one or more nodes between the current node of the progression path of the subject entity and the subsequent node of the progression path of the first entity; and
generating a portion of a message from the subject entity to the second entity.

18. The processor-readable storage device of claim 16, wherein the operations further comprise:
identifying a historical progression path for the subject entity, the historical progression path comprising a set of historical nodes associated with the subject entity and occurring prior to a specified node; and
based on the historical progression path for the subject entity, determining a set of potential nodes for the progression path for the subject entity and occurring subsequent to the specified node, a portion of nodes within the progression path of the subject entity corresponding to the set of historical nodes.

19. The processor-readable storage device of claim 16, wherein identifying the progression path for the first entity further comprises:
identifying a set of entities from the distinct entities represented by the data clusters;
for each entity of the set of entities, determining a probability of a node of a progression path of the entity corresponding to the potential node of the progression path of the subject entity; and
ranking the set of entities based on the probabilities determined for each entity of the set of entities.

20. The processor-readable storage device of claim 19, wherein determining the probability of the node of the entity corresponding to the potential node of the progression path of the subject entity further comprises:
determining a set of potential nodes for the progression path for the subject entity; and
for each potential node of the set of potential nodes, determining a probability of the potential node being a next node in the progression path for the subject entity.
